(19) United States
(12) Patent Application Publication
(10) Pub. No.: US 2014/0356599 A1
(43) Pub. Date: Dec. 4, 2014

(54) WINDOW FOR DISPLAY DEVICE AND DISPLAY DEVICE INCLUDING THE WINDOW PANEL

(71) Applicant: SAMSUNG DISPLAY CO., LTD., Yongin-City (KR)

(72) Inventors: YUKI HONGO, Yongin-City (KR); JU-SUK OH, Yongin-City (KR); JEE-SEOK OH, Yongin-City (KR); KWAN-YOUNG HAN, Yongin-City (KR)

(73) Assignee: SAMSUNG DISPLAY CO., LTD., Yongin-City (KR)

(21) Appl. No.: 14/056,188

(22) Filed: Oct. 17, 2013

(30) Foreign Application Priority Data
Jun. 4, 2013 (KR) 10-2013-0064157

(51) Int. Cl. G02B 1/10; B29C 45/14; B29C 45/16; B29C 45/00

(52) U.S. Cl. CPC G02B 1/105; B29C 45/0001; B29C 45/14336; B29C 45/1642; B29K 2667/003
USPC 428/215; 428/522; 428/520; 428/412; 428/483; 428/337; 428/220; 264/279

(57) ABSTRACT

A window for a display device includes a polymer resin layer including a polymer resin having a tensile elongation at break point of no less than about 20% and a tensile modulus of no less than about 2.1 GPa and a light transmittance film disposed on at least one side of the polymer resin layer.

### RELATED APPLICATIONS

This application claims priority to Korean Patent Application No. 10-2013-0064157 filed on Jun. 4, 2013, the disclosure of which is hereby incorporated by reference herein in its entirety.

### TECHNICAL FIELD

A window for a display device and a display device including the same are disclosed.

### DISCUSSION OF THE RELATED ART

Currently known display devices include, for example, a liquid crystal display (LCD), a plasma display panel (PDP), an organic light emitting diode display (OLED), a field effect display (FED), an electrophoretic display device, and the like.

Such a display device includes a display module displaying an image and a window protecting the display module.

The window may be made of, for example, glass. However, as the glass may be easily broken by an external impact, when the glass is applied to a portable device such as, for example, a mobile phone, the window may consequently be easily damaged. Therefore, a window made of a plastic material instead of glass has recently been researched.

However, as a display device having a touch screen function is used, a hand or a sharp tool such as a pen may frequently contact one side of the window. In this case, the window made of plastic may be easily scratched on the surface. In addition, the window made of plastic may undergo appearance deformation such as, for example, curl or waiving.

### SUMMARY

An embodiment provides a window for a display device that prevents appearance deformation while increasing impact resistance simultaneously.

An embodiment provides a display device including the window.

According to an embodiment, a window for a display device includes a polymer resin layer including a polymer resin having a tensile elongation at break point of no less than about 20% and a tensile modulus of no less than about 2.1 GPa, and a light transmittance film disposed on at least one side of the polymer resin layer.

The polymer resin may include polymethylmethacrylate (PMMA).

The polymer resin may have a tensile modulus of no less than about 2.4 GPa.

The light transmittance film may include a plastic substrate including at least one selected from the group consisting of a polyethyleneterephthalate (PET) film, a polycarbonate (PC) film, a polymethylmethacrylate (PMMA) film, and a polycarbonate/polymethylmethacrylate (PC/PMMA) film.

The light transmittance film may further include a binder layer disposed between the polymer resin layer and the plastic substrate.

The binder layer may have a glass transition temperature (Tg) of about 50° C. to about 110° C.

The binder layer may have a glass transition temperature (Tg) of about 60° C. to about 90° C.

The binder layer may include an acryl-based resin or a polyester-based resin.

The plastic substrate has a thickness of about 50 μm to about 200 μm and the binder layer has a thickness of about 5 μm to about 20 μm.

The light transmittance film may further include a hard coating layer disposed on one side of the plastic substrate.

The hard coating layer may include one of an organic material, an inorganic material, or an organic/inorganic composite compound.

The polymer resin layer may have a thickness of about 200 μm to about 800 μm.

The window for a display device may have a thickness of no greater than about 1 mm.

The window for a display device may have a thickness of about 0.3 mm to about 1 mm.

The window for a display device may have a heat distortion temperature of no less than about 90° C. measured according to JIS K7191-1 under about a 1.8 MPa load condition.

The window for a display device may be obtained by injection-molding the light transmittance film and the polymer resin in a film insert manner.

According to another embodiment, a display device including the window for a display device is provided.

An embodiment of the present invention provides a window for a display device including a polymer resin layer including a polymer resin having a tensile elongation at break point in a range of from about 20% to about 200% and a tensile modulus in a range of from about 2.1 GPa to about 4.0 GPa. The polymer resin includes polymethylmethacrylate (PMMA), and the polymer resin layer has a thickness of about 200 μm to about 800 μm.

The window for the display device further includes a light transmittance film including a binder layer disposed on the polymer resin layer, a plastic substrate disposed on an upper surface of the binder layer and a hard coating layer including one of an organic material, an inorganic material, or organic/inorganic composite compound and disposed on an upper surface of the plastic substrate. The binder layer has a glass transition temperature (Tg) in a range of 50° C. to about 110° C. and includes one of an acryl-based resin or a polyester-based resin.

In addition, the window for a display device has a thickness of about 0.3 mm to about 1 mm.

An embodiment of the present invention provides a method for manufacturing a window for a display device. The method includes forming a light transmittance film and injection-molding the light transmittance film and a polymer resin in a film insert manner to form the light transmittance film on at least one side of a polymer resin layer including the polymer resin, thereby forming the window for the display device.

The polymer resin of the polymer resin layer has a tensile elongation at break point of no less than about 20% and a tensile modulus of no less than about 2.1 GPa.

The window for a display device according to exemplary embodiments prevents appearance deformation while increasing impact resistance.

### BRIEF DESCRIPTION OF THE DRAWING

Exemplary embodiments of the present invention can be understood in further detail from the following detailed description taken in conjunction with the attached drawing in which:

FIG. 1 is a cross-sectional view of a window for a display device according to an embodiment.

### DETAILED DESCRIPTION OF EXEMPLARY EMBODIMENTS

Exemplary embodiments will hereinafter be described more fully with reference to the accompanying drawings, in which exemplary embodiments of the invention are shown. However, exemplary embodiments of the present invention may, be embodied in many different forms and should not be construed as being limited to exemplary embodiments set forth herein.

In the drawings, the thickness of layers, films, panels, regions, etc. may be exaggerated for clarity. Like reference numerals designate like elements throughout the specification. It will be understood that when an element such as a layer, film, region, or substrate is referred to as being “on” another element, it can be directly on the other element or intervening elements may also be present.

As used herein, the singular forms, “a”, “an”, and “the” are intended to include plural forms as well, unless the context clearly indicates otherwise.

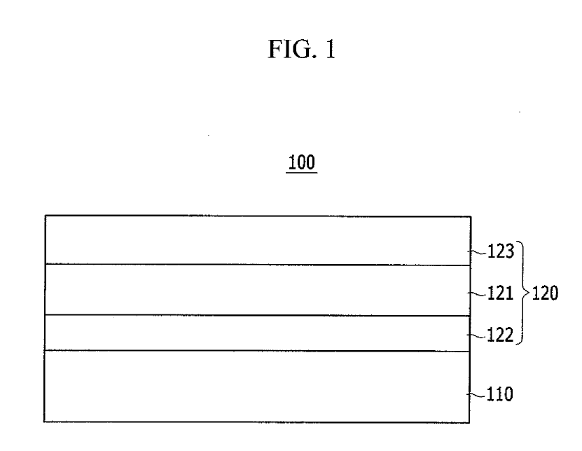

Referring to FIG. 1, a window for a display device according to an embodiment will be described.

FIG. 1 is a cross-sectional view of a window for a display device according to an embodiment.

The window 100 for the display device according to the present embodiment includes, for example, a polymer resin layer 110 and a light transmittance film 120 positioned on one side of the polymer resin layer 110.

For example, the polymer resin layer 110 may be made of an injection moldable polymer resin, and the polymer resin may be selected from a resin satisfying a tensile elongation at break point of no less than about 20% and a tensile modulus of no less than about 2.1 GPa simultaneously.

The tensile elongation at break point indicates how much a polymer resin may be elongated at a predetermined rate, and the polymer resin has a tensile elongation at break point within the range and thus, may secure impact resistance of a window for a display device. The polymer resin may have a tensile elongation at break point in a range of, for example, about 20% to about 200% within the range.

According to an embodiment, the window 100 for the display device may have a tensile modulus of, for example, no less than about 2.1 GPa. In an embodiment, the window 100 for the display device may have a tensile modulus of, for example, no less than about 2.4 GPa. When the window 100 for the display device has a tensile modulus within the range, surface hardness and strength of the window are increased. The window 100 for the display device may have a tensile modulus in the range of, for example, about 2.4 GPa to about 4.0 GPa. Thus, in an embodiment, the window 100 for the display device may have a tensile modulus in the range of, for example, about 2.1 GPa to about 4.0 GPa.

When the window 100 for the display device has a device tensile elongation at break point and a tensile modulus within the above-mentioned ranges, the window 100 for the display device may obtain satisfactory impact resistance and appearance.

The polymer resin having a tensile elongation at break point and a tensile modulus within the above-mentioned ranges may include, for example, polymethylmethacrylate (PMMA) but exemplary embodiments of the present invention are not limited thereto.

The polymer resin layer 110 may have a heat distortion temperature of no less than about 90° C. The heat distortion temperature is measured according to, for example, JIS K7191-1 under about a 1.8 MPa load condition.

The light transmittance film 120 includes, for example, a plastic substrate 121, a binder layer 122, and a hard coating layer 123.

The plastic substrate 121 is used for a film insert forming process, and may be, for example, a polyethyleneterephthalate (PET) film, a polycarbonate (PC) film, a polymethylmethacrylate (PMMA) film, a polycarbonate/polymethylmethacrylate (PC/PMMA) film, a polyimide film, a polyacrylate film, a polyethyleneetherphthalate film, a polyethylene naphthalate film, a polyarylate film, a polyetherimide film, a polyethersulfone film, a cellulose triacetate film, a polyvinylidene chloride film, a polyvinylidene fluoride film, an ethylene-vinylalcohol copolymer film, or a combination thereof.

The plastic substrate 121 may have a thickness of, for example, about 50 μm to about 200 μm.

The binder layer 122 is interposed between the polymer resin layer 110 and the plastic substrate 121 for bonding the polymer resin layer 110 and the light transmittance film 120 to each other. The binder layer 122 may include, for example, an acryl-based binder or a polyester-based binder.

The binder layer 122 may have a thickness of, for example, about 5 μm to about 20 μm.

The binder layer 122 may have a glass transition temperature (Tg) of, for example, about 50° C. to about 110° C. For example, in an embodiment, the binder layer 122 may have a glass transition temperature (Tg) of, for example, about 60° C. to about 90° C. When the binder layer 122 has a glass transition temperature (Tg) within the above-mentioned ranges, close contacting properties between the polymer resin layer 110 and light transmittance film 120 may be secured.

The hard coating layer 123 is positioned on the surface of the window 100 for the display device and furthermore may increase surface hardness. The hard coating layer 123 may include, for example, an organic material, an inorganic material, or an organic/inorganic composite compound. Herein the organic material may include, for example, an acryl-based compound, an epoxy-based compound, a urethane-based compound or a combination thereof. The inorganic material may include, for example, silica, alumina, titanium oxide, zirconium oxide, magnesium oxide, calcium carbonate, talc, clay, calcined kaolin, calcined calcium silicate, hydrated calcium silicate, aluminum silicate, magnesium silicate, calcium phosphate, or a combination thereof. The organic/inorganic composite compound may include, for example, polysilsesquioxane. The hard coating layer 123 may be a monolayer or a plural layer, and may have a thickness, for example, of about 5 μm to about 150 μm.

The light transmittance film 120 may be, for example, an IMD film (In mold decoration film).

The light transmittance film 120 is formed on one side of the polymer resin layer 110 but exemplary embodiments of the present invention are not limited thereto. For example, in an embodiment, the light transmittance film 120 is formed, for example, on both sides of the polymer resin layer 110.

The window 100 for the display device may be obtained by, for example, injection-molding the light transmittance film 120 and the polymer resin in a film insert manner.

The polymer resin layer 110 may have a thickness of, for example, about 200 μm to about 800 μm.

The window 100 for the display device may have a thickness of, for example, no greater than about 1 mm. For example, in an embodiment, the window 100 may have a thickness in the range of about 0.3 mm to about 1 mm.

When the window 100 for the display device and the polymer resin layer 110 each have a thickness within the above-mentioned ranges, a sufficient space that the polymer resin flows in during the injection-molding in a film insert manner may be secured and impact resistance and surface hardness characteristics of the above-described polymer resin may be secured, and good appearance may be obtained.

The above described window 100 for the display device may be applied to various display devices. The display device may be, for example, a liquid crystal display (LCD), an organic light emitting diode (OLED) display, a plasma display, an electric field effect display device, an electrophoresis display device, and the like, but exemplary embodiments are not limited thereto.

The window 100 for the display device may be disposed on a display module. The display module may be, for example, a liquid crystal display module, an organic light emitting display module, a plasma display module, an electric field effect display module, an electrophoresis display module, and the like.

Hereinafter, exemplary embodiments of the present invention are illustrated in more detail with reference to examples. However, these examples are exemplary, and exemplary embodiments of the present disclosure are not limited thereto.

### Manufacture of Window for Display Device

### Example 1

A hard coating solution (OPSTER KZ6445A, JSR Co.) was coated to be about 10 μm thick on about a 100 μn-thick PET film (PET100A4300, TOYOBO Co., Ltd.) and dried at about 80° C. for about 1 minute. Subsequently, the dried hard coating solution was cured by radiating an ultraviolet (UV) ray in a dose of about 300 mJ/cm².

Subsequently, a binder solution having a Tg temperature of about 82° C. (EF-42, Soken Chemical Co. Ltd.) was coated to be about 10 μm thick on the other side of the hard coating solution and dried at about 100° C. for about 10 minutes.

Subsequently, the PET film was put in an injection molder to injection-mold about a 580 μm-thick polymethylmethacrylate (PMMA) resin (SR8200, Asahi KASEI Chemical Co.) having characteristics provided in the following Table 1, to manufacture about a 0.7 mm-thick window for a display device.

TABLE 1

| | | Heat distortion | |
|---|---|---|---|
| | Tensile elongation | temperature | Tensile |
| | at break point (%) | (° C.) | modulus (GPa) |
| PMMA resin | about 20 | about 96 | about 2.4 |

Herein, the tensile elongation at a break point was measured with a reference to JIS C2151, the heat distortion temperature with a reference to JIS K7191-1 under a load condition of about 1.8 MPa, and the tensile modulus was measured with a reference to JIS K7161.

### Example 2

An about 0.7 mm-thick window for a display device was manufactured according to the same method as Example 1 except for using a polymethylmethacrylate (PMMA) resin (HT55X, Sumitomo Chemical Co. Ltd.) having characteristics provided in the following Table 2.

TABLE 2

| | | Heat distortion | |
|---|---|---|---|
| | Tensile elongation | temperature | Tensile |
| | at break point (%) | (° C.) | modulus (GPa) |
| PMMA resin | about 38 | about 94 | about 2.5 |

### Example 3

An about 0.5 mm-thick window for a display device was manufactured according to the same method as Example 1 except for forming the polymethylmethacrylate (PMMA) resin to be about 380 μm thick.

### Example 4

An about 0.7 mm-thick window for a display device was manufactured according to the same method as Example 1 except for using a binder solution having a Tg temperature of about 67° C. (Vylon 200, TOYOBO Co., Ltd.).

### Example 5

An about 0.7 mm-thick window for a display device was manufactured according to the same method as Example 1 except for using a binder solution having a Tg temperature of about 34° C. (UR-5537, TOYOBO Co., Ltd.).

### Comparative Example 1

An about 0.7 mm-thick window for a display device was manufactured according to the same method as Example 1 except for using a polymethylmethacrylate (PMMA) resin (VR L40, Mitsubishi Rayon Co., Ltd.) having characteristics provided in the following Table 3.

TABLE 3

| | | Heat distortion | |
|---|---|---|---|
| | Tensile elongation | temperature | Tensile |
| | at break point (%) | (° C.) | modulus (GPa) |
| PMMA resin | about 30 | about 94 | about 2.0 |

### Comparative Example 2

An about 0.7 mm-thick window for a display device was manufactured according to the same method as Example 1 except for using a polymethylmethacrylate (PMMA) resin (MG5, Mitsubishi Rayon Co. Ltd.) having characteristics provided in the following Table 4.

TABLE 4

| | | Heat distortion | |
|---|---|---|---|
| | Tensile elongation | temperature | Tensile |
| | at break point (%) | (° C.) | modulus (GPa) |
| PMMA resin | about 3 | about 99 | about 3.1 |

### Evaluation

Impact resistance, appearance, and close contacting property of the windows for a display device according to Examples 1 to 4 and Comparative Examples 1 to 3 were evaluated.

The impact resistance was measured by dropping about 130 g of a metal drop in the center of a window for a display device with a ball drop measurement device, and a maximum height where the window had no crack was recorded.

The appearance was evaluated by examining if the window for the display device was bent or deformed at a temperature of about 85° C. after about 100 hours with naked eyes.

The close contacting property was evaluated to determine if the window for the display device was delaminated at a temperature of about 85° C. after about 100 hours.

The results are provided in Table 5.

TABLE 5

| | Impact | | Close contacting |
|---|---|---|---|
| | resistance | Appearance | property |
| Example 1 | about 30 cm | OK | No delamination |
| Example 2 | about 30 cm | OK | No delamination |
| Example 3 | about 30 cm | OK | No delamination |
| Example 4 | about 30 cm | OK | No delamination |
| Example 5 | about 30 cm | OK | Delamination |
| Comparative | about 40 cm | NG | No delamination |
| Example 1 | | | |
| Comparative | Less than | OK | No delamination |
| Example 2 | about 10 cm | | |

Referring to Table 5, the windows for a display device according to Examples 1 to 4 showed high impact resistance and satisfactory appearance. On the contrary, the windows for the display device using a polymer resin having a low tensile elongation at tensile modulus according to Comparative Example 1 showed unsatisfactory appearance, while the windows for the display device using a polymer resin having a low break point according to Comparative Example 2 showed low impact resistance.

Based on the results, when a polymer resin had a tensile elongation at break point and tensile modulus within a predetermined range, both impact resistance and appearance characteristic were satisfactory.

Having described exemplary embodiments of the present invention, it is further noted that it is readily apparent to those of ordinary skill in the art that various modifications may be made without departing from the spirit and scope of the invention which is defined by the metes and bounds of the appended claims.

What is claimed is:

1. A window for a display device, comprising:
a polymer resin layer including a polymer resin having a tensile elongation at break point of no less than about 20% and a tensile modulus of no less than about 2.1 GPa; and
a light transmittance film disposed on at least one side of the polymer resin layer.

2. The window for a display device of claim 1, wherein the polymer resin comprises polymethylmethacrylate (PMMA).

3. The window for a display device of claim 1, wherein the polymer resin has a tensile modulus of no less than about 2.4 GPa.

4. The window for a display device of claim 1, wherein the light transmittance film comprises a plastic substrate comprising at least one selected from the group consisting of a polyethyleneterephthalate (PET) film, a polycarbonate (PC) film, a polymethylmethacrylate (PMMA) film, and a polycarbonate/polymethylmethacrylate (PC/PMMA) film.

5. The window for a display device of claim 4, wherein the light transmittance film further comprises a binder layer disposed between the polymer resin layer and the plastic substrate.

6. The window for a display device of claim 5, wherein the binder layer has a glass transition temperature (Tg) of about 50° C. to about 110° C.

7. The window for a display device of claim 6, wherein the binder layer has a glass transition temperature (Tg) of about 60° C. to about 90° C.

8. The window for a display device of claim 5, wherein the binder layer comprises one of an acryl-based resin or a polyester-based resin.

9. The window for a display device of claim 5, wherein the plastic substrate has a thickness of about 50 μm to about 200 μm and wherein the binder layer has a thickness of about 5 μm to about 20 μm.

10. The window for a display device of claim 4, wherein the light transmittance film further comprises a hard coating layer disposed on one side of the plastic substrate.

11. The window for a display device of claim 10, wherein the hard coating layer comprises one of an organic material, an inorganic material, or an organic/inorganic composite compound.

12. The window for a display device of claim 1, wherein the polymer resin layer has a thickness of about 200 μm to about 800 μm.

13. The window for a display device of claim 1, wherein the window for a display device has a thickness of no greater than about 1 mm.

14. The window for a display device of claim 13, wherein the window for a display device has a thickness of about 0.3 mm to about 1 mm.

15. The window for a display device of claim 1, wherein the window for a display device has a heat distortion temperature of no less than about 90° C. measured according to JIS K7191-1 under about a 1.8 MPa load condition.

16. A display device comprising the window for a display device according to claim 1.

17. A window for a display device, comprising:
a polymer resin layer including a polymer resin having a tensile elongation at break point in a range of from about 20% to about 200% and a tensile modulus in a range of from about 2.1 GPa to about 4.0 GPa, wherein the polymer resin comprises polymethylmethacrylate (PMMA), wherein the polymer resin layer has a thickness of about 200 μm to about 800 μm;
a light transmittance film comprising a binder layer disposed on the polymer resin layer, a plastic substrate disposed on an upper surface of the binder layer and a hard coating layer comprising one of an organic material, an inorganic material, or organic/inorganic composite compound and disposed on an upper surface of the plastic substrate, wherein the binder layer has a glass transition temperature (Tg) in a range of 50° C. to about 110° C. and comprises one of an acryl-based resin or a polyester-based resin,
and wherein the window for a display device has a thickness of about 0.3 mm to about 1 mm.

18. A method for manufacturing a window for a display device, comprising:
forming a light transmittance film; and
injection-molding the light transmittance film and a polymer resin in a film insert manner to form the light transmittance film on at least one side of a polymer resin layer including the polymer resin, thereby forming the window for the display device,
wherein the polymer resin of the polymer resin layer has a tensile elongation at break point of no less than about 20% and a tensile modulus of no less than about 2.1 GPa.

19. The method of claim 18, wherein the forming of the light transmittance film comprises:
forming a hard coating layer on a plastic substrate, and
forming a binder layer on an opposite side of the plastic substrate from the hard coating layer.

20. The method of claim 19, wherein the light transmittance film comprises a plastic substrate comprising at least one selected from the group consisting of a polyethyleneterephthalate (PET) film, a polycarbonate (PC) film, a polymethylmethacrylate (PMMA) film, and a polycarbonate/polymethylmethacrylate (PC/PMMA) film.
